(19) United States
(12) Patent Application Publication
(10) Pub. No.: US 2026/0123596 A1
(43) Pub. Date: May 7, 2026

(54) LITTER BOX

(71) Applicant: JIANGSU ERLANGSHEN PLASTIC CO., LTD, YANGZHOU, (CN)

(72) Inventors: Yuan Gong, YANGZHOU, (CN); Kang Zhao, YANGZHOU, (CN)

(73) Assignee: JIANGSU ERLANGSHEN PLASTIC CO., LTD, YANGZHOU, JIANGSU (CN)

(21) Appl. No.: 19/069,380

(22) Filed: Mar. 4, 2025

(30) Foreign Application Priority Data
Nov. 1, 2024 (CN) 2024226731125
Dec. 4, 2024 (CN) 2024229876164

(51) Int. Cl. A01K 1/01

(52) U.S. Cl. CPC A01K 1/0114

(57) ABSTRACT

A cat litter box provided includes a base and a cat compartment, the cat compartment is detachably mounted to the base and rotatable relative to the base, the cat compartment includes a first shell component, and a second shell component, the first shell component and the second shell component being removably assembled together to form the cat compartment. These components can be directly and operatively assembled together without the need for external fasteners or tools. This design not only reduces packaging volume and facilitates transportation but also simplifies the assembly process, making it more convenient.

### CROSS REFERENCE TO RELATED APPLICATION

This non-provisional patent application claims priority under 35 U.S.C. § 119 from the Chinese Patent Application No. 202422673112.5 filed on Nov. 1, 2024, and the Chinese Patent Application No. 202422987616.4 filed on Dec. 4, 2024, entire content of which is incorporated herein by reference.

### TECHNICAL FIELD

The disclosure relates to pet supplies technology, and particularly to a litter box.

### BACKGROUND

With the continuous improvement of living standards, an increasing number of households choose pets as daily companions, with a relatively high proportion of people feeding cats and other pets. Cats require specialized litter boxes for excretion, and litter in the litter boxes needs to be cleaned regularly.

Nowadays, automatic litter boxes are commonly. However, typical automatic litter boxes generally include a cat compartment and a base, and the cat compartment features a unitary design. The cat compartment, which must permit cats to enter and leave freely, is generally of a larger size. The unitary design of the cat compartment creates substantial difficulties for packaging and transporting.

Therefore, there is a room for improvement in the automatic litter boxes.

### SUMMARY

In view of this, it is necessary to provide a litter box that is easy to pack and transport.

A cat litter box provided includes a base and a cat compartment, the cat compartment is detachably mounted to the base and rotatable relative to the base, the cat compartment includes a first shell component, and a second shell component, the first shell component and the second shell component being removably assembled together to form the cat compartment.

The aforementioned litter box features a cat compartment divided into a first shell component and a second shell component. These components can be directly and operatively assembled together without the need for external fasteners or tools. This design not only reduces packaging volume and facilitates transportation but also simplifies the assembly process, making it more convenient.

### BRIEF DESCRIPTION OF THE DRAWINGS

In order to more clearly illustrate the technical solutions in the embodiments of disclosure or the prior art, the following provides a brief introduction to the drawings required for describing the embodiments or the prior art. It is obvious that the drawings in the following description are merely some embodiments of disclosure. For ordinary technicians in the field, without creative efforts, other drawings can be obtained based on the structures shown in these drawings.

FIG. 1 is a first exploded view of the structure of a cat litter box in accordance with an embodiment.

FIG. 2 is a second exploded view of the structure of the cat litter box in accordance with an embodiment.

FIG. 3 is a third exploded view of the structure of the cat litter box in accordance with an embodiment.

FIG. 4 is a fourth exploded view of the structure of the cat litter box in accordance with an embodiment.

FIG. 5 is a perspective view of the cat litter box in accordance with an embodiment.

FIG. 6 is a top view of the cat litter box in accordance with an embodiment.

FIG. 7 is a sectional view taken along section line A-A in FIG. 6.

FIG. 8 is a perspective view of a cat compartment in accordance with an embodiment.

FIG. 9 is a sectional view taken along section line B-B in FIG. 8.

FIG. 10 is a schematic diagram of a partial structure of the cat litter box in accordance with an embodiment.

FIG. 11 is an enlarged view of the circled portion C in FIG. 10.

FIG. 12 is a first exploded view of the structure of the cat compartment in accordance with an embodiment.

FIG. 13 is a schematic diagram of the coupling connection between a first coupling part and a second coupling part in accordance with an embodiment of.

FIG. 14 is a first structural schematic diagram of a pull latch in accordance with an embodiment.

FIG. 15 is a second structural schematic diagram of the pull latch in accordance with an embodiment.

FIG. 16 is a first exploded view of the structure of a latch in accordance with an embodiment.

FIG. 17 is a second exploded view of the structure of the latch in accordance with an embodiment.

FIG. 18 is a second exploded view of the structure of the cat compartment in accordance with an embodiment.

FIG. 19 is a first exploded view of the structure of a base in accordance with an embodiment.

FIG. 20 is a second exploded view of the structure of the base in accordance with an embodiment.

FIG. 21 is an exploded view of the structure of a driving device in accordance with an embodiment.

FIG. 22 is an exploded view of the structure of an auxiliary roller in accordance with an embodiment.

FIG. 23 is an exploded view of the structure of a top cover in accordance with an embodiment.

FIG. 24 is a first perspective view of a waste collection compartment provided in an embodiment.

FIG. 25 is a second perspective view of the waste collection compartment provided in an embodiment.

FIG. 26 is a top view of the waste collection compartment provided in an embodiment.

FIG. 27 is a sectional view taken along section line A-A in FIG. 26.

FIG. 28 is an enlarged schematic view of the circled portion B in FIG. 27.

FIG. 29 is a bottom view of the waste collection compartment provided in an embodiment.

FIG. 30 is a sectional view taken along section line C-C in FIG. 29.

FIG. 31 is a perspective view of a hook shown in FIG. 24.

The achievement of the objectives, functional characteristics, and advantages of the present disclosure will be further described with reference to the embodiments and accompanying drawings.

### DETAILED DESCRIPTION

In the description of the disclosure, it should be understood that the terms “length”, “width”, “up”, “down”, “front”, “rear”, “left”, “right”, “vertical”, “horizontal”, “top”,′ “bottom”, “inner”, “outer”, and other similar terms indicating orientation or positional relationships are based on the orientation or positional relationships depicted in the accompanying drawings. These are solely for the purpose of facilitating the description of the disclosure and simplifying the description, rather than indicating or implying that the devices or components referred to must have specific orientations, be constructed or operated in specific orientations. Therefore, they should not be construed as limitations of the disclosure.

Furthermore, the terms “first” and “second” are used solely for descriptive purposes and should not be understood as indicating or implying relative importance or implying the number of technical features indicated. Consequently, features qualified by “first” and “second” may explicitly or implicitly include one or more of such features. In the description of the disclosure, the term “plurality” means two or more, unless otherwise specifically and clearly defined.

In the disclosure, unless otherwise specifically defined and limited, terms such as “install”, “connect”, “link”, “fix”, and others should be broadly interpreted. For example, they can refer to fixed connections, detachable connections, or integral formations; mechanical connections or electrical connections; direct connections or indirect connections through intermediary media; internal communication between two elements or interaction between two elements. For those skilled in the art, the specific meanings of these terms in the disclosure can be understood based on specific circumstances.

To provide a clearer and more accurate understanding of the content of the disclosure, a detailed description will now be provided in conjunction with the accompanying drawings. The accompanying drawings illustrate examples of embodiments of the disclosure, where identical labels denote identical elements. It should be understood that the proportions shown in the accompanying drawings are not those of the actual implementation of the disclosure but are solely for illustrative purposes and are not drawn to scale.

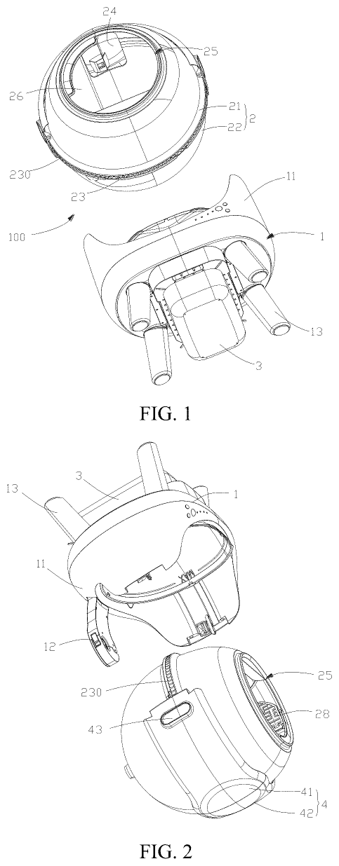

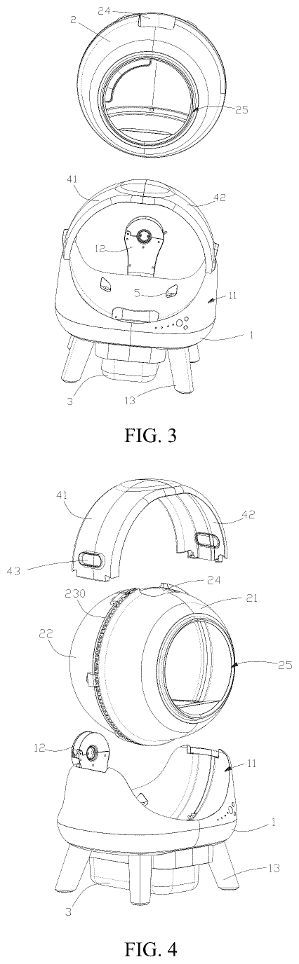

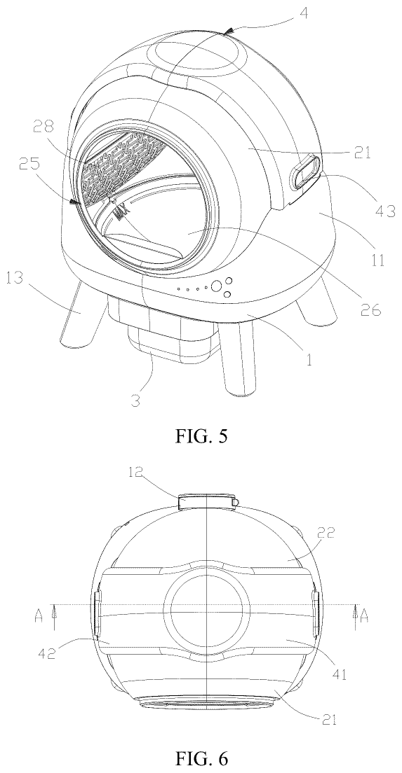

Referring to FIG. 1, the disclosure provides a cat litter box 100. The cat litter box 100 includes a base 1, a cat compartment 2, and a driving device 6. The driving device 6 is disposed on the base 1. The cat compartment 2 is detachably mounted on the base 1 and connected to the driving device 6. The cat compartment 2 can rotate relative to the base 1 when driven by the driving device 6.

In this embodiment, the cat compartment 2 is a hollow sphere. The cat compartment 2 defines a compartment cavity 26 filled with cat litter. The cat compartment 2 also defines a compartment entrance 25 and an first waste opening 24 both communicating with the compartment cavity 26. The compartment opening 25 allows cats to enter and exit the compartment cavity 26, in other words, the cats can enter and exit the cat litter box 100 through the compartment opening 25. When the cats excrete, their waste falls onto the cat litter and the cat compartment 2 is then rolled to clean it up, automatically refreshing the cat litter.

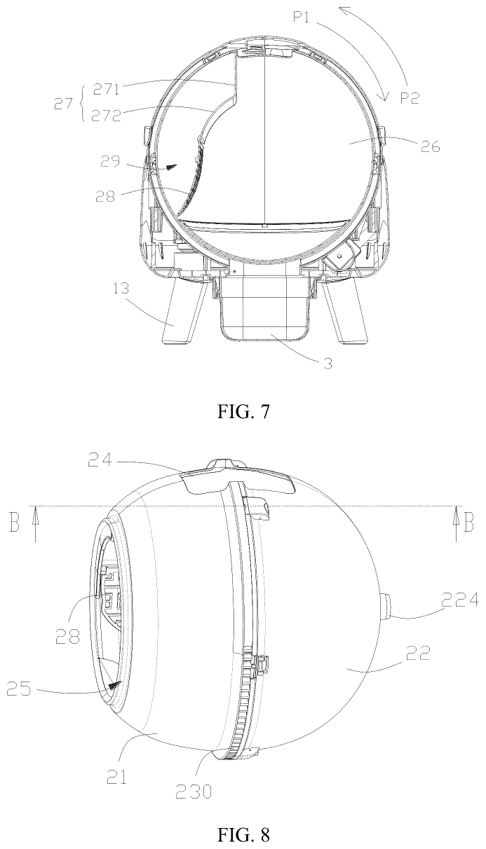

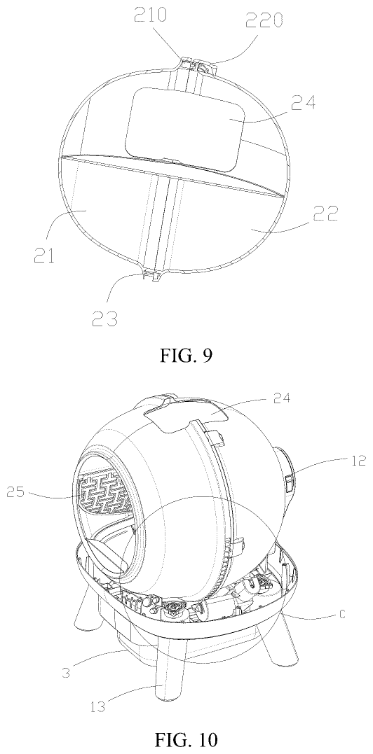

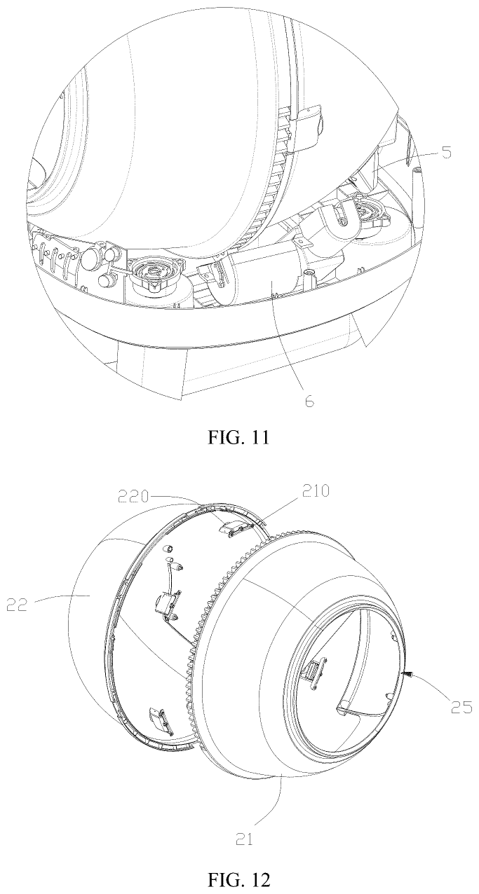

The cat compartment 2 includes first shell component 21 and second shell component 22 that can be detachably assembled together. In this embodiment, the first shell component 21 is the front shell of the cat compartment 2, with the compartment opening 25 disposed on the first shell component 21. The second shell component 22 is the rear shell of the cat compartment 2. In other words, in this embodiment, the cat compartment 2 is split into two parts from the front and rear, namely, the first shell component 21 and the second shell component 22. Therefore, a junction 23 between the first shell component 21 and the second shell component 22 circles around along the direction of rolling of the cat compartment 2. As shown by P1 and P2 in FIG. 7, the rotation directions of the cat compartment 2 include a first rotation direction P1 and a second rotation direction P2. In other words, the junction 23 is a ring structure surround the cat compartment 2 along a moving trajectory of the cat compartment 2. It is understandable that in some other embodiments, the cat compartment 2 can also be split into two parts along the up-down direction, so the junction 23 between the first shell component 21 and the second shell component 22 intersects with moving trajectory of the cat compartment 2.

The first shell component 21 and the second shell component 22 are equipped with a plurality of pairs of first coupling portions 210 and second coupling portions 220. Each pair of the first coupling portion 210 and the second coupling portion 220 can be namely the first coupling portion 210 and the corresponding second coupling portion 220, can be operatively engaged or disengaged. In other words, the first shell component 21 and the second shell component 22 are allowable to be assembled together solely by manipulating the first coupling portions 210 and second coupling portions 220, without the need for any additional tools or fasteners (such as rods, bolts, screws, etc.), thus simplifying the assembly process. Meanwhile, since the cat compartment 2 can be disassembled into the first shell component 21 and the second shell component 22, the packaging volume can be greatly reduced, facilitating transportation. The first coupling portions 210 and the second coupling portions 220 can be assembled via snapping, screwing, or other means.

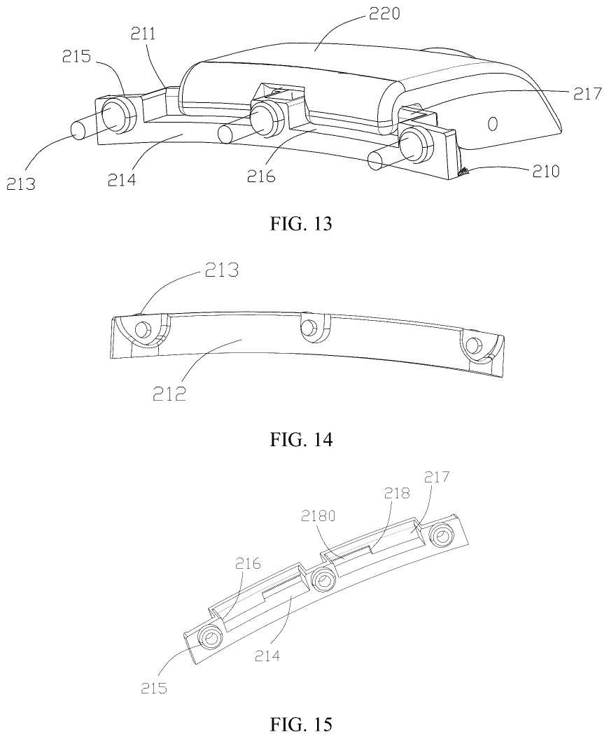

Referring to FIGS. 12-15, the first shell component 21 and the second shell component 22 are assembled together via snapping. The first coupling portion 210 includes a pull latch 211 fixed to the first shell component 21. The pull latch 211 has an approximately arcuate strip shape, with inner side 212 secured to the first shell component 21 using fasteners 213, such as screws or bolt. The pull latch 211 includes a rectangular base side 214, along which three fixing portions 215 are spaced and arranged in a row. Mating openings 216 are formed between each pair of adjacent fixing portions 215. Additionally, two engagement walls 217 extend upwardly from one end of the base side 214, each positioned between two adjacent fixing portions 215. Each fixing portion 215 is connected at one end to the first shell component 21. The engagement walls 217 are positioned at the opposite end of the fixing portions 215, distant from the first shell component 21. Together, the two engagement walls 217, the three fixing portions 215, and the base side 214 form two latching openings 218. Additionally, a latching groove 2180 is located on the side of each engagement wall 217 that faces the first shell component 21.

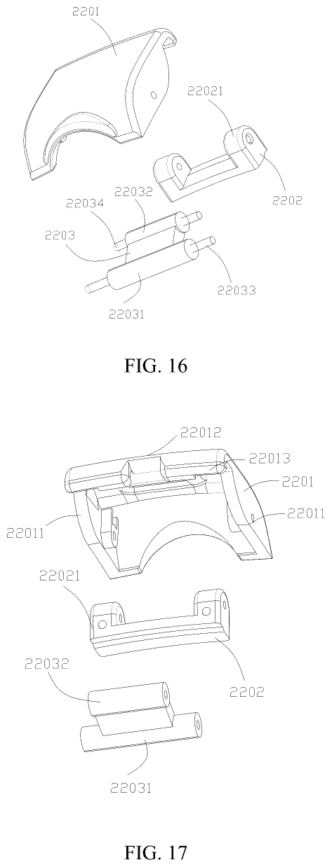

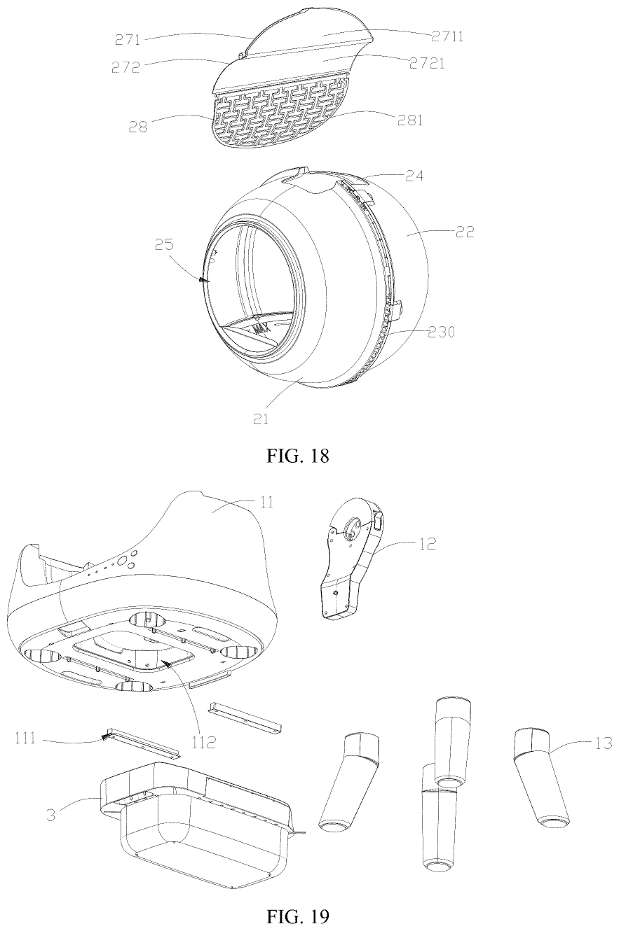

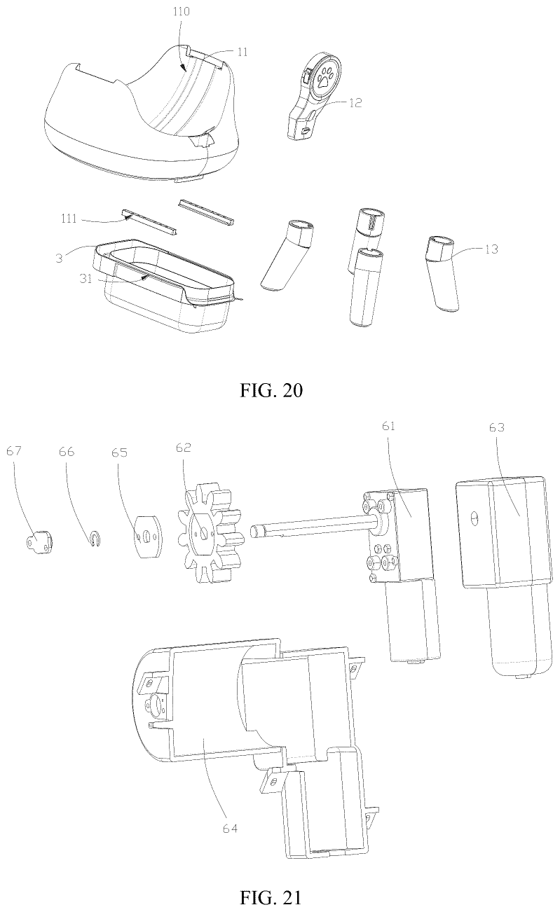

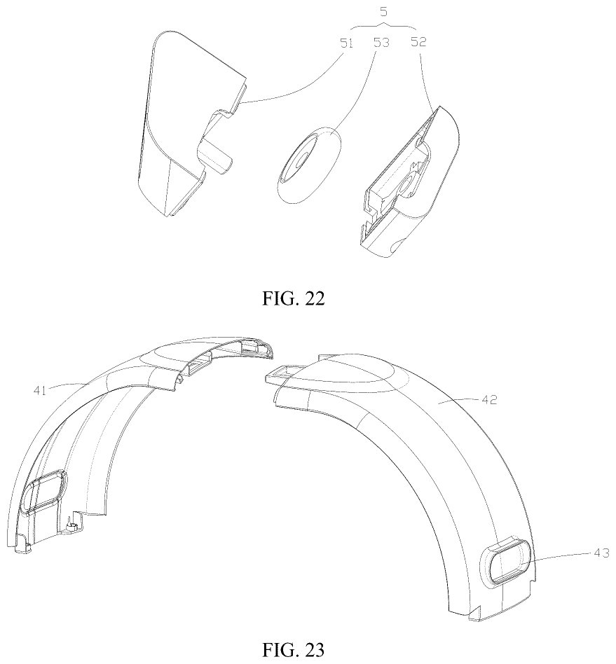

Referring to FIGS. 16-17, the second coupling portion 220 is positioned correspondingly to the first coupling portion 210. The second coupling portion 220 includes a locking latch 221. When the pull latch 211 and the locking latch 221 are engaged together, the first shell component 21 is coupled with the second shell component 22 The second coupling portion 220 also includes a mounting portion 222 and a pivoting portion 223. Specifically, the mounting portion 222 is securely attached to the second shell component 22. The pivoting portion 223 connects the locking latch 221 to the mounting portion 222 in a pivotal manner, enabling the locking latch 221 to rotate in relation to the second shell component 22. Through the locking latch 221, the second coupling portion 220 engages with the engagement walls 217, thus assembling the first shell component 21 and the second shell component 22 together with the aid of the first coupling portion 210 and the second coupling portion 220.

The locking latch 221 includes two side walls 2211 disposed opposite each other, and an engagement section 2212 located away from the second shell component 22, which is connected between the two side walls 2211. The engagement section 2212 protrudes toward the first shell component 21, featuring two latching hooks 2213 spaced-apart, which serve to latch with the pull latch 211, thereby making up the locking latch 221.

The mounting portion 222 features two lugs 2221 disposed opposite each other. The pivoting portion 223 includes the first pivoting portion 2231 and the second pivoting portion 2232 spaced-apart. The first pivoting portion 2231 is connected to the mounting portion 222 via a first pivoting axis 2233, which runs between the two lugs 2221, allowing the first pivoting axis 2233 to pivotally attach to the mounting portion 222. The second pivoting portion 2232, on the other hand, is connected to the side walls 2211 of the locking latch 221 via a second pivoting axis 2234, enabling the locking latch 221 to rotate relative to the second shell component 22. When the locking latch 221 is rotated downward until it is parallel to the cat compartment 2, the two latching hooks 2213 are inserted into their corresponding latching grooves 2180 through the latching openings 218. This action engages the latching hooks 2213 with the engagement walls 217, securely locking the locking latch 221 to the engagement walls. Consequently, the second coupling portion 220 becomes coupled to the first coupling portion 210. Conversely, when the locking latch 221 is rotated upward, the latching hooks 2213 disengage from the latching grooves 2180, decoupling the second coupling portion 220 from the first coupling portion 210.

In this embodiment, the cat litter box compartment 2 is also equipped with a gear rack 230, and an assembly portion 224. Specifically, the gear rack 230 is positioned at the junction 23 of the first shell component 21 and the second shell component 22, designed to engage with the driving device 6. The gear rack 230 extends from one side of the first waste opening 24, which is situated at this junction 23, along the interface. The length of the gear rack 230 is tailored to accommodate a rolling amplitude of the cat litter box compartment 2. Meanwhile, the assembly portion 224, which is a bearing, is mounted on the second shell component 22. This allows the cat litter box compartment 2 to rotate smoothly on the base 1 via the assembly portion 224. Notably, in this disclosure, the first waste opening 24 is positioned precisely at the junction 23 of the first and second shell components 21 and 22.

The cat litter box 100 further includes a blocking member 27 positioned within the compartment chamber 26, and a litter screen 28 positioned adjacent to the blocking member 27. The litter screen 28 is pivotally connected to the cat litter box compartment 2. A litter collecting space 29 is formed between the blocking member 27 and an interior of the cat litter box compartment 2, the blocking member 27 includes a first blocking member 271, and a second blocking member 272 integrally formed with the first blocking member 271. The first blocking member 271 includes a vertical plane 2711 facing away from the litter collecting space 29. The second blocking member 272 includes a first curved surface 2721 protruding towards the litter collecting space 29. The litter screen 28 is positioned adjacent to the second blocking member 272 and includes a second curved surface 281 protruding away from the litter collecting space 29. When the cat litter box compartment 2 rotates or rolls, the blocking member 27 and the litter screen 28 work together to segregate the cat litter from waste. The waste then rolls along the blocking member 27 towards the first waste opening 24 and is subsequently discharged from the compartment 2 through the first waste opening 24.

In this embodiment, the base 1 includes a base housing 11, a support shaft 12 that is removably mounted to the base housing 11 and extend upwards from the base housing 11, a plurality of support legs 13, and a waste collection compartment 3. The multiple support legs 13 are positioned underneath the base housing 11 to provide stability and support Specifically, on one side of the base housing 11 that faces the support legs 12 defines a second waste opening 112. When the first waste opening 24 is align with the second waste opening 112, the cat litter box compartment 2 becomes interconnected with the waste collection compartment 3, thereby enabling waste to fall from the cat litter box compartment 2 into the waste collection compartment 3. The base housing 11 is a partially open chamber, which features an arcuate mounting cavity 110, a shape of the mounting cavity 110 is compatible with that of the cat litter box compartment 2, allowing for partially accommodating the cat litter box compartment 2. One end of the support shaft 12 far from the base housing 11 is rotatably connected to the assembly portion 224, thereby rotatably connecting the cat litter box compartment 2 to the base 1 and supporting the cat litter box compartment 2. A bottom of the base housing 11 defines two opposite sliding grooves 111. The waste collection compartment 3 is positioned beneath the base housing 11 and located at the position where the first waste opening 24 passes, for collecting waste discharged from the first waste opening 24 inside. Optionally, the waste collection compartment 3 is located at the middle position beneath the base housing 11. One side of the waste collection compartment 3 facing the base housing 11 is disposed with two corresponding sliding rails 31. The waste collection compartment 3 can be separated or installed by being drawn out from the base housing 11 through the cooperation of the sliding rails 31 and the sliding grooves 111. When the cat litter box compartment 2 rotates, the waste move along the blocking member 27 toward the first waste opening 24, and the waste is discharged through the first waste opening 24 into the waste collection compartment 3.

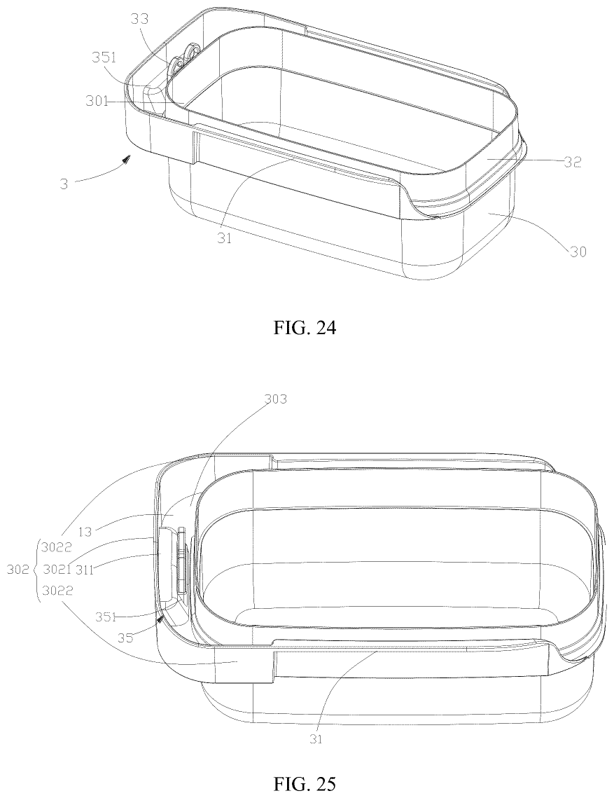

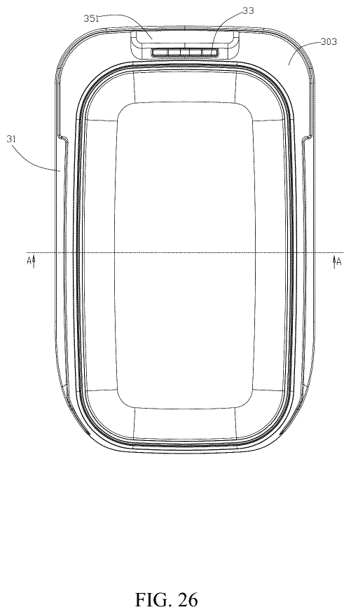

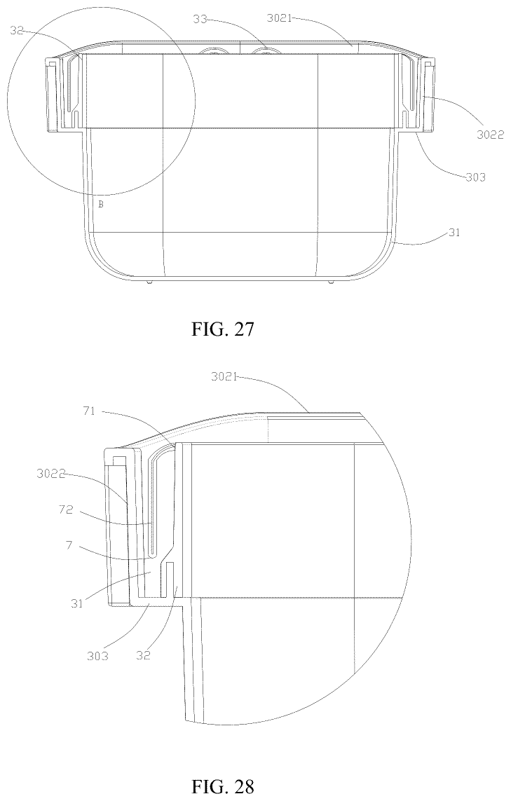

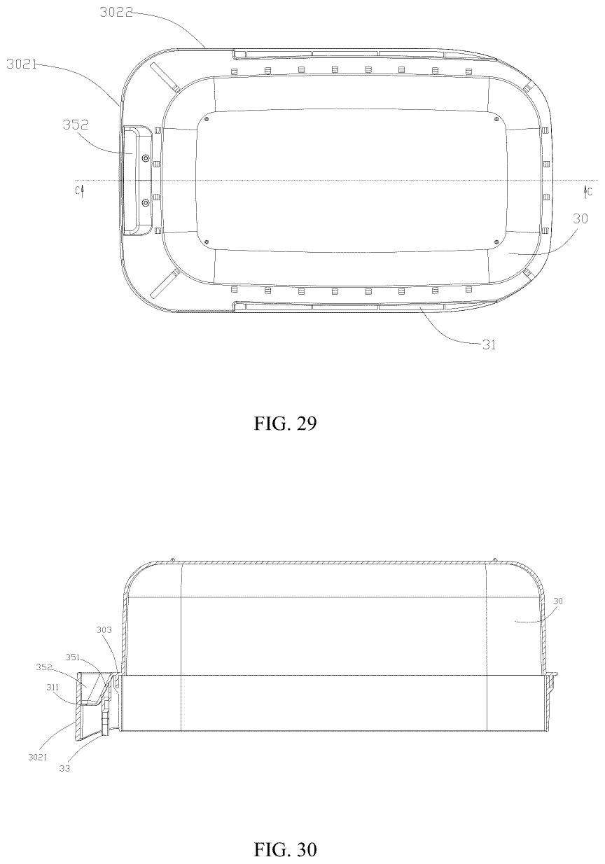

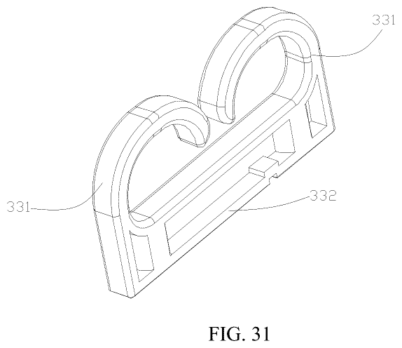

Referring to FIGS. 24-31, the waste collection compartment 3 is used in conjunction with a collection bag 7 to collect cat litter and/or clump of the cat litter that result from the absorption of feline excretions, including urine and feces, by the litter.

The collection bag 7 includes a drawstring portion 71, and a drawstring 72 wound inside the drawstring portion 71. The drawstring portion 71 defines a pull opening to expose a segment of the drawstring 72, enabling a user to pull the drawstring 72 out from the pull opening to tighten drawstring portion 71 and effectively close collection bag 7.

When the waste collection compartment 3 is installed on the base 1, the waste collection compartment 3 is positioned beneath the cat compartment 2. The waste collection compartment 3 includes a compartment body 30, a bag enclosing portion 32, and a hook 33. The compartment body 30 and features a collection chamber 301 with an open end designed for inserting the collection bag 7. The bag enclosing portion 32 is positioned on the compartment body 30, surrounding the open end to securely hold the drawstring portion 71 of the collection bag 7. The hook 33 is detachably mounted on one side of the compartment body 30, and configured to secure the drawstring 72 of the collection bag 7 that passes through the hook 33.

In this embodiment, the bag enclosing portion 32 is a frame constructed from a deformable material, making it flexible. In contrast, the compartment body 30 is rigid. Specifically, if the compartment body 30 and the bag enclosing portion 32 are made of a first material and a second material, respectively, the first material has a higher hardness than the second material. The first material includes, but is not limited to, polypropylene (PP) and high-density polyethylene (HDPE), while the second material includes, but is not limited to, silicone and natural rubber. Additionally, the compartment body 30 and the bag enclosing portion 32 are integrally formed. This is achieved through a two-step molding process: the first step forms the compartment body 30, and the second step forms both the compartment body 30 and the bag enclosing portion 32, resulting in a streamlined and efficient manufacturing sequence.

The compartment body 30 includes a surrounding wall 302 partially enclosing the bag enclosing portion 32, and a mating plate 303 connected between the bag enclosing portion 32 and the surrounding wall 302. In this embodiment, the mating plate 303 is positioned at an end of the surrounding wall 302 far from sliding rails 31. Ends of the bag enclosing portion 32 and the surrounding wall 302 far from the mating plate 303 are substantially aligned. A space is formed between the surrounding wall 302 and the bag enclosing portion 32 to form a bag enclosing space 14 for accommodating the drawstring portion 71. The surrounding wall 302 includes a first surrounding wall 3021 and two opposite second surrounding walls 3022, with the two second surrounding walls 3022 respectively connected to two ends of the first surrounding wall 3021. Thus, the first surrounding wall 3021 is located between the two second surrounding walls 3022. The two second surrounding walls 3022 are recessed towards the bag enclosing portion 32 to form the sliding rails 31 at the end of the surrounding wall 302. In this embodiment, the sliding rails 31 is located at the opening of the compartment body 30. The sliding rails 31 is used to install the compartment body 30 on the base 1.

The waste collection compartment 3 further includes a pulling portion 35 positioned on the mating plate 303. A protrusion 351 is formed on one side of the pulling portion 35 facing the opening, while a recess 352 is formed on the opposite side of the protrusion. The recess 352 is designed to allow users to conveniently pull the compartment body 2 away from or place it onto the base 1. Additionally, a mounting block 311 is positioned on a side of the protrusion 351 facing the bag enclosing portion 32.

In this embodiment, the hook 33 is located between the surrounding wall 302 and the bag enclosing portion 32, and is removably mounted on the side of the protrusion 351 facing the bag enclosing portion 32. More specifically, the hook 33 is positioned between the first surrounding wall 3021 and the bag enclosing portion 32, and is removably mounted together with the protrusion 351. The hook 33 includes a mounting portion 332 and two opposite hook ears 331 positioned on the mounting portion 332. Hook portions of the two hook ears 331 are located on the inner side thereof. When the drawstring 72 passes through the hook 33, the drawstring 72 can be hooked by the two hook ears 331. The mounting portion 332 is mounted on the protrusion 351 in cooperation with a plurality of fixing elements, and thus mounted on the protrusion 351. In addition, the hook 33 is located on one side of the protrusion 351 facing the bag enclosing portion 32, so that the hook 33 can rely on the protrusion 351, thereby strengthening the strength of the hook 33 and making it less prone to damage. The fixing elements include but are not limited to threaded rods, screws, bolts, and the like. The assembly means of the hook 33 and the protrusion 351 includes but is not limited to snap-fitting, screwing, and other assembly methods.

When installing the collection bag 7 on the waste collection compartment 3, first, open and place the collection bag 7 inside the waste collection compartment 3, then turn the drawstring portion 1111 inside out to cover the bag enclosing portion 32, and simultaneously, the drawstring 72 is also placed around the bag enclosing portion 32; next, pull the drawstring 72 out to a certain length from the pull opening and pass it through the hook 33.

When it is necessary to clean or replace the cat litter, the cat litter and/or clump of the cat litter will enter the collection cavity 11 through the opening, thereby entering the collection bag 7. The clump of the cat litter refers to a solid mass formed when clumping cat litter absorbs moisture, such as urine, from a cat's waste. The clumping action causes the litter particles to bind together, creating a firm, scoopable clump that can be easily removed from the litter box, leaving the remaining litter clean and dry.

When the collection bag 7 is full or needs to be replaced for other reasons, the drawstring 72 can be operatively pulled out to a longer length from the opening, and the hook 33 blocks the drawstring portion 71, so that drawstring portion 71 detaches from the bag enclosing portion 32 under the force of the drawstring 72, and drawstring portion 71 is tightened by the drawstring 72 to close/seal the collection bag 7. In this disclosure, the user only needs to operate the exposed portion of the drawstring 72 of the collection bag 7 to seal and remove the collection bag 7 covering the waste collection compartment 3, which not only avoids the user repeatedly touching the easily contaminated bag opening of the collection bag 7 but also improves the convenience of removing the collection bag 7 from the waste collection compartment 3.

Since the bag enclosing portion 32 is made of deformable material, when the waste collection compartment 3 is installed on the compartment body 30, the bag enclosing portion 32 can deform to closely adhere to the compartment body 30, so that the collection cavity 11 forms a sealed space, reducing the odor spillage of cat litter and excrement in the waste collection compartment 3.

In this embodiment, the hook 33 is removably mounted on the warehouse body 1. Since the hook 33 is the main force-bearing component when replacing the collection bag 7, it can be replaced in the case where the hook 33 may be damaged. That is, the waste collection compartment 3 can be maintained at low cost.

The driving device 6 having a motor 61 and a drive gear 62, is mounted on the base housing 11. The drive gear 62 is connected to the motor 6 and meshes with the linear gear rack 230 mounted on the cat litter box compartment 2. During operation, the motor 61 rotates the drive gear 62, thereby translating rotational motion of the drive gear 62 into linear displacement of the cat litter box compartment 2 through rack-and-pinion interaction between the drive gear 62 and the linear gear rack 230. In the disclosure, the driving device 6 further includes a motor bracket 64 configured to fixedly secured the motor 61, a motor enclosure 63 concentrically disposed about the motor 61, a motor bearing for connecting the motor 61 to the drive gear 62, and a motor shaft washer 65, a retaining ring 66, and a motor shaft sleeve 67 located at the motor bearing.

The cat litter box 100 further includes auxiliary roller assembly 5 which are idler rollers. The auxiliary roller assembly 5 are configured to assist the rolling motion of the cat litter box compartment 2 when actuated by the driving device 6, thereby enhances the operational stability of the cat litter box compartment 2 during rolling and reduces frictional wear, thereby minimizing potential damage to the components. Each auxiliary roller 5 includes a first roller bracket 51, a second roller bracket 52, and a wheel 53. The first roller bracket 51 and the second roller bracket 52 are assembled to define a rolling space configured to accommodating the wheel 53. In one embodiment, two auxiliary roller assembly 5 are mounted on outer walls of the first shell component 21 and the second shell component 21 respectively with each auxiliary roller 5 positioned in proximity to the base 1. This configuration enhances structural stability and facilitates smooth rolling motion.

The top cover 4 includes a first top cover 41 and a second top cover 42. The distal ends of the first top cover 41 and the second top cover 42 are fixed to the base 1, respectively, and include handles 43 to facilitate handling of the cat litter box 100. The proximal ends of the first top cover 41 and the second top cover 42 are interconnected through mutual insertion, providing a secure and seamless connection. This arrangement enhances structural integrity, functionality, and user convenience.

In the above embodiment, the cat litter box compartment can be divided into a first shell component and a second shell component, and the first shell component and the second shell component can be operably assembled together without the need for external fasteners or tools. This not only reduces packaging volume and facilitates transportation but also facilitates assembly.

Obviously, those skilled in the art can make various modifications and variations to the disclosure without departing from the spirit and scope of the disclosure. Thus, if these modifications and variations of the disclosure fall within the scope of the claims and their equivalents, the disclosure also intends to include these modifications and variations.

The above-enumerated embodiments are merely preferred embodiments of the disclosure and cannot be used to limit the scope of rights of the disclosure. Therefore, equivalent changes made according to the claims of the disclosure still fall within the scope covered by the disclosure.

1. A cat litter box, wherein the cat litter box includes:
a base; and
a cat compartment, detachably mounted to the base, the cat compartment being rotatable relative to the base, the cat compartment comprising:
a first shell component, and
a second shell component, the first shell component and the second shell component being removably assembled together to form the cat compartment, and after assembled, the first and second shell components being readily disassembled from each other without requiring any tools by users; wherein the cat compartment is spherical, a junction between the first shell component and the second shell component extends circumferentially along the direction of rolling of the cat compartment; wherein the cat compartment defines a compartment cavity, and a first waste opening communicating with the compartment cavity; the cat litter box also includes a drive device mounted on the base, the cat compartment also has a rack gear mounted on the first shell component to engage with the drive device; the rack gear extends from one side of the first waste opening along the junction.

2. (canceled)

3. The cat litter box according to claim 1, wherein the first shell component and the second shell component are equipped with a plurality of pairs of first coupling portions and second coupling portions, that enables the first shell component and the second shell component to be assembled or disassembled.

4. The cat litter box according to claim 3, wherein the first coupling portion includes a pull latch fixed to the first shell component, and the second coupling portion includes a locking latch that locks with the pull latch to couple the first shell component and the second shell component together.

5. The cat litter box according to claim 4, wherein the pull latch is provided with two spaced-apart latch walls, each latch wall defines a latch groove on a side facing the first shell component; the second coupling portion further includes a mounting portion, and a hinging portion, the mounting portion is fixed to the second shell component, the hinging portion connected the locking latch to the mounting portion, allowing the locking latch to rotate relative to the second shell component; the lock latch protrudes towards the first shell component with two spaced-apart first hooks, the locking latch is locked to the latch walls by inserting the two first hooks into the corresponding latch grooves, respectively, thereby coupling the second coupling portion to the first coupling portion.

6. (canceled)

7. The cat litter box according to claim 6, wherein the drive device includes a motor and a drive gear, the drive gear partially protruding from the base to engage with the rack gear; when the motor is operated, the drive gear is driven by the motor and drives the cat compartment to roll via the rack gear.

8. The cat litter box according to claim 6, wherein the cat litter box also includes a blocking member positioned in the compartment cavity, and a litter screen located adjacent to the blocking member, the litter screen is hinged to the cat compartment, a litter collecting space is formed between the blocking member and the interior of the cat compartment, and the blocking member comprise an integrally formed first blocking member and a second blocking member, the first blocking member including a vertical plane facing away from the litter collecting space, the second blocking member including a first curved surface protruding towards the litter collecting space, the litter screen is located adjacent to the second blocking member and including a second curved surface protruding away from the litter collecting space.

9. The cat litter box according to claim 8, wherein the second shell component includes a mounting portion, the base includes a base housing defining a second waste opening, a support shaft removably fixed to the base housing, a plurality of support legs, the support shaft extending from the base housing towards above the base housing and rotatably connected to the mounting portion, thereby rotatably connecting the cat compartment to the base; the plurality of support legs are located below the base housing to support the base housing; when the cat compartment rolls, the litter screen is configured to separate cat litter and waste, the waste rotating along the blocking member to the first waste opening and discharging out of the cat compartment from the first waste opening and the second waste opening.

10. The cat litter box according to claim 8, wherein the base housing defines an arcuate mounting groove, the cat litter box also includes an arcuate top cover, a shape of the top cover is compatible with that of the junction, two opposite ends of the top cover are respectively fixed to the base and far away from the base housing, thereby enclosing an installation space together with the base housing for accommodating the cat compartment and exposing two sides of the first shell component and the second shell component facing away from each other; at the same time, the top cover also covers the opening; the top cover includes a first top cover and a second top cover, the two ends of the first top cover and the second top cover facing away from each other being respectively fixed to the base, and the other ends of the first top cover and the second top cover are mutually inserted and connected.

11. The cat litter box according to claim 9, further comprising a waste collection compartment, the waste collection compartment is mounted to the base and at the position where the second waste opening passes, and collected the clump and/or the cat litter from the cat litter compartment.

12. The cat litter box according to claim 11, wherein the base housing defines two opposite sliding grooves, the waste collection compartment has two corresponding sliding rails, and the waste collection compartment can be assembled or disassembled on the base housing via the sliding rails and the sliding grooves, the waste collection compartment comprises:
an integrated formed compartment body with a collecting cavity, the compartment body having an open end for inserting a collection bag to collect the cat litter and the clump, the collection bag including a drawstring portion, and a drawstring wound inside the drawstring portion, the drawstring portion defining an opening for partially exposing a portion of the drawstring, the drawstring being operable to be pulled out from the opening;
a deformable bag enclosing portion surrounding the opening, which holds the drawstring portion and the drawstring in place; and
a hook removably mounted on one side of the compartment body, through which the exposed portion of the drawstring passes, when the drawstring is pulled to a certain length, the drawstring portion detaches from the bag enclosing portion under the force of the drawstring, and the drawstring portion is tightened under tension, and the drawstring tightens to securely close the collection bag.

13. The cat litter box according to claim 11, wherein the compartment body includes a surrounding wall partially enclosing the bag enclosing portion, a bag enclosing space is formed between the surrounding wall and the bag enclosing portion for accommodating the drawstring portion; the sliding rails are positioned at one end of the surrounding wall, the sliding rails are located at the opening of the compartment body for mounting the compartment body to the base.

14. The cat litter box according to claim 13, wherein the hook is located between the surrounding wall and the bag enclosing portion, the surrounding wall including a first surrounding wall opposite and adjacent to the hook, and two opposite second surrounding walls, the two second surrounding walls are connected to both ends of the first surrounding wall; the two second surrounding walls recess towards the bag enclosing portion to form sliding rails at distal ends of the two second surrounding walls.

15. The cat litter box according to claim 13, wherein the waste collection compartment further includes a mating plate connected between the surrounding wall and the compartment body, the mating plate being located at an end of the surrounding wall away from the sliding rails; the waste collection compartment further includes a pulling portion positioned at the mating plate, a protrusion is formed on one side of the pulling portion facing the opening, while a recess is formed on the opposite side of the protrusion, the recess is designed to allow the users to pull the compartment body away from or place it onto the base; the hook is located on one side of the protrusion facing the bag enclosing portion.

16. The cat litter box according to claim 15, wherein the bag enclosing portion and the distal end of the surrounding wall are substantially flush.

17. The cat litter box according to claim 16, wherein the hook includes a mounting portion and two opposite hook ears positioned at the mounting portion; a mounting block the side of the protrusion facing the bag enclosing portion is positioned on a side of the protrusion facing the bag enclosing portion.

18. The cat litter box according to claim 16, wherein when the compartment body is mounted on the base, the waste collection compartment is located beneath the base housing.

19. The cat litter box according to claim 11, wherein the compartment body is rigid and is integrally formed with the bag enclosing portion.

20. A cat litter box, comprising:
a base; and
a cat compartment of a spherical shape, detachably mounted to the base, the cat compartment being rotatable relative to the base, the cat compartment comprising:
a first shell component, and
a second shell component, the first shell component and the second shell component being detachably assembled to form the cat compartment without the need for any external tools during regular use, and during transportation, the first and second shell components being disassembled from each other together so as to form the cat compartment.

21. The cat litter box according to claim 19, a junction between the first shell component and the second shell component extends circumferentially along the direction of rolling of the cat compartment; wherein the cat compartment defines a compartment cavity, and an first waste opening communicating with the compartment cavity; the cat litter box also includes a drive device mounted on the base, the cat compartment also has a rack gear mounted on the first shell component to engage with the drive device; the rack gear extends from one side of the first waste opening along the junction.
